(19) United States
(12) Patent Application Publication
(10) Pub. No.: US 2014/0377726 A1
(43) Pub. Date: Dec. 25, 2014

(54) Vocational Education Portal

(71) Applicant: Amrita Vishwa Vidyapeetham, Tamil Nadu (IN)

(72) Inventors: R. Bhavani Rao, Kerala (IN); Jamie Sara Otelsberg, Agoura Hills, CA (US); Rangasrinivasan Venkataraman, Tamil Nadu (IN)

(73) Assignee: Amrita Vishwa Vidyapeetham, Tamil Nadu (IN)

(21) Appl. No.: 14/283,587

(22) Filed: May 21, 2014

Related U.S. Application Data
(60) Provisional application No. 61/838,034, filed on Jun. 21, 2013.

(51) Int. Cl. G09B 5/02; G09B 19/00

(52) U.S. Cl. CPC G09B 5/02; G09B 19/00
USPC 434/219; 434/350

(57) ABSTRACT

A method has steps for (a) logging in to an on-line vocational education portal by a person seeking to gain vocational training; (b) guiding the person, by the vocational portal, through an aptitude test; (c) directing the person to one or more on-line vocational courses based on the aptitude test results; (d) guiding the user, by the vocational portal, through one or more assessment tests, determining the person's mastery of the one or more vocational courses; completion of the on-line course curriculum, the user is provided an assessment test; and (e) providing and recording a certification to the person based upon successful completion of the one or more assessment tests.

### CROSS-REFERENCE TO RELATED APPLICATIONS

The present application claims priority to U.S. Provisional Patent Application Ser. No. 61/838,034, filed on Jun. 21, 2013, the disclosure of which is hereby incorporated in its entirety at least by reference.

### BACKGROUND OF THE INVENTION

1. Field of the Invention

The present invention is in the technical field of on-line educational systems. More particularly, the present invention relates to a vocational education portal.

2. Description of Related Art

Since the Internet has become widely available, many on-line educational systems have been put into place. On-line educational systems have experienced fast growth and have started to replace physical education systems.

One benefit of on-line educational systems is that the courses and training are available at any time in any location. Students no longer need to travel to a specific classroom site. Another advantage is that the cost of providing on-line educational systems is significantly less than the cost of a traditional classroom education.

As the cost of traditional education continues to rise, many skilled jobs are left unfilled. In the past, vocational schools were available to fill this void. However, vocational schools and training have been continually declining over the last half-century. Consequently, there is a need for an on-line educational system that provides vocational training for unemployed and underemployed persons, as a means for enterprises to prepare and recruit qualified persons.

### BRIEF SUMMARY OF THE INVENTION

In one embodiment of the invention a method is provided comprising steps: (a) logging in to an on-line vocational education portal by a person seeking to gain vocational training; (b) guiding the person, by the vocational portal, through an aptitude test; (c) directing the person to one or more on-line vocational courses based on the aptitude test results; (d) guiding the user, by the vocational portal, through one or more assessment tests, determining the person's mastery of the one or more vocational courses; completion of the on-line course curriculum, the user is provided an assessment test; and (e) providing and recording a certification to the person based upon successful completion of the one or more assessment tests.

In one embodiment the method further comprises steps for determining a geographic location for the person and presenting interfaces to the user in a language native to the geographic location. Also in one embodiment, in step (c), the on-line vocational courses are provided by businesses that are located in close proximity to the geographical location of the user. Also in one embodiment, in step (c), the entity is a local business and the on-line course curriculum is intended to train the user in a trade that is specific to the local business.

In one embodiment the certification meets an international standard. Also in one embodiment there is a step provided wherein the user is recruited for employment by a business that is located in close proximity to the geographical location of the user. And in one embodiment the entity is a local business and the on-line course curriculum is provided to train the user in a trade that is specific to the local business.

In another aspect of the invention a system is provided comprising an Internet-connected computerized appliance having a processor and coupled to a data repository, the processor executing software from a non-transitory medium, the software providing an interactive interface to a vocational education system, the system enabling a user to log on and select a language, create an account, search through available courses, take an aptitude test, complete a course curriculum, take an assessment test, gain a certification, search for employment, and network with peers.

In one embodiment of the system the language is auto-suggested based on the geographical location of the user. In one embodiment course curriculum is provided by a business that is located in close proximity to the geographical location of the user. And in one embodiment the course curriculum trains the user in a trade that is specific to the local business.

### BRIEF DESCRIPTION OF THE SEVERAL VIEWS OF THE DRAWINGS

FIG. 1 is an architectural diagram of an Internet computer network system according to an embodiment of the present invention.

FIG. 2 is a flow diagram illustrating steps a student may take to utilize the vocational education portal according to an embodiment of the present invention.

FIG. 3 is a flow diagram illustrating steps wherein local businesses may train and recruit qualified skilled workers by utilizing the vocational education portal according to an embodiment of the present invention.

### DETAILED DESCRIPTION OF THE INVENTION

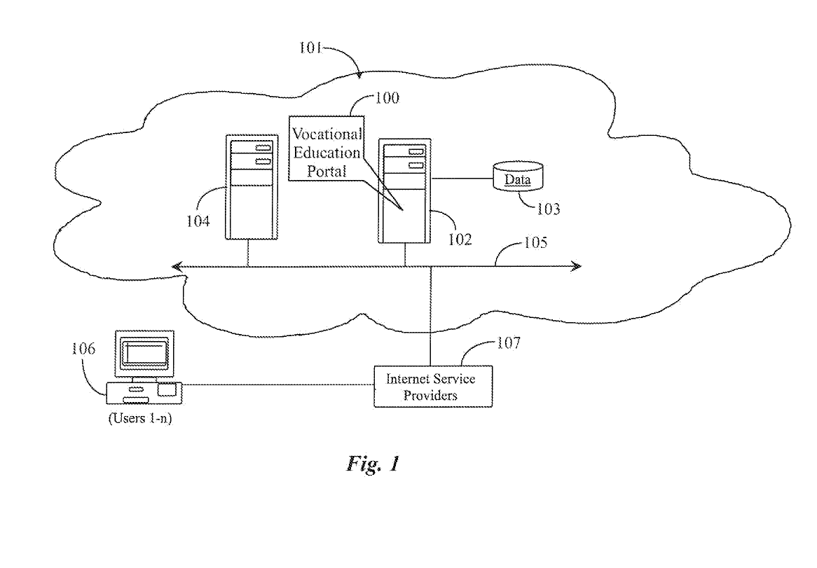

FIG. 1 is an architectural diagram of an Internet-connected computer system according to an embodiment of the present invention. The Internet-connected system comprises one or more servers 102 in Internet network 101, having one or more processors executing vocational education portal software 100 from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 are connected to the Internet-connected server via an Internet service provider (ISP) 107, representing all of the ways that persons may connect to the Internet, allowing users 106 to access the vocational education portal. Users may be a variety of entities, including but not limited to, unskilled and semi-skilled persons, students, teachers, governments, guilds, education institutions, content providers, businesses, and non-government organizations (NGOs).

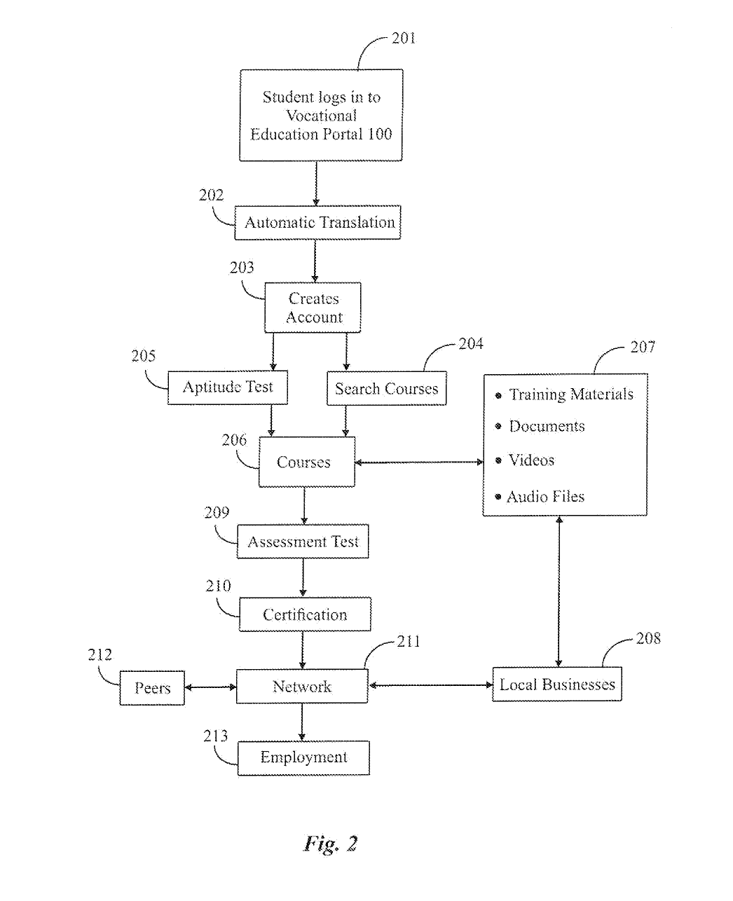

FIG. 2 is a flow diagram illustrating steps a student may take to utilize the vocational education portal. At step 201 a student logs in to vocational education portal 100. The student may be any semi-skilled, unskilled, or marginalized person, chronically unemployed and the like. The portal may be accessible from regional vocational centers or remotely. Remote access is available from a variety of devices and technology platforms, including but not limited to, desktop computers, laptops, tablets, and smartphones. This allows students to access the portal from essentially any location.

In step 202, which is an optional step, the language of the portal is automatically translated into the regional language of the student. The language selection in some embodiments is based on the geolocation from where the portal is being accessed. The student will also have the ability to select a specific language, and in response the portal will present interfaces to the student in the selected language. In step 203, the student registers and creates an account, as is well known in the art. If the student has a specific trade or specific skill they wish to expand, they may search courses 204 available for that specific trade or vocation. Alternatively, if the student does not have a specific trade in mind, the portal may recommend a trade and competency level based on the results of an aptitude test 205.

Next, in step 206, the student may register for courses. Once registered, the student has access to a plurality of resources 207, including training materials, documents, videos, and audio files. The resources further include video lectures, interactive multimedia workbooks, an interactive 3D glossary, simulation training and evaluations. The courses and corresponding resources 207 are created and provided by businesses 208. This ensures potential employees are trained proficiently. In one embodiment the portal is partitioned by geolocation so that local businesses may create course to be accessed by local students, and later employment features may be used to match students with open employment opportunities locally, such that students may not have to relocate to accept employment opportunities.

After completion of courses 206, the student is given an assessment test 209, which tests the student's competency levels for the specific trade. Once the student successfully passes the assessment test, the student is provided a certification 210. The certification allows the student to gain credibility for potential employers. Likewise, the certification allows the standardization of skill levels across multiple communities and countries to meet international standards.

In the circumstance wherein a student does not pass the assessment test or tests, that student may be invited to register for one or more classes that may be designed to address exactly those areas where the student may have fallen short of competency on the assessment tests.

Still referring to FIG. 2, the student has access to a network 211, which connects local businesses 208 to certified students in an employment sub-system. From this network the student may gain internships or employment 213 from local businesses seeking certified students in a specific trade. Likewise, the student may network with peers 212 to further their skills and career by searching for other employment opportunities online. The network includes, in some embodiments, an ability to be interfaced and fully-integrated with existing social media sites, so students may access the functionality of the portal through their own networking space.

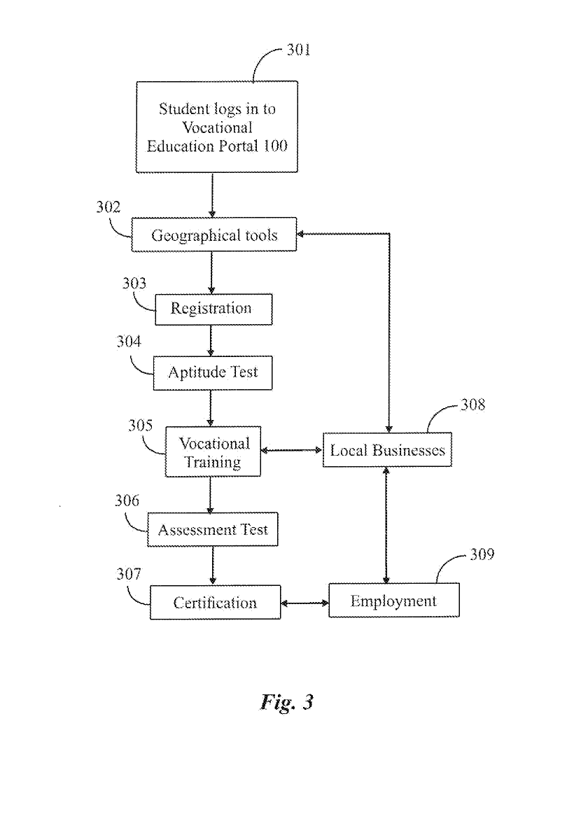

FIG. 3 is a flow diagram illustrating steps wherein local businesses 308 may train and recruit qualified workers by utilizing the vocational education portal. In step 301, a student logs in to vocational education portal 100. Next, geographical tools 302 are initiated. Specifically, the language selection as the medium of learning may be provided based on the location from where the portal is being accessed. Once the student registers at step 303, the student is directed to vocational training 305 based on the results of an aptitude test 304. The vocational training is provided by local businesses 308 and is specific to their own businesses. The group of available businesses is provided by the geographical tools and the corresponding geolocation of the student. This ensures that employers in need of qualified workers may train students in a specific trade necessary for employment in their businesses. An assessment test 306 is given to students to quantify their competency level for a specific trade. Once a pre-determined competency level is reached, the student will gain certification 307 for that specific trade.

After a student is certified, they may be recruited for employment 309 from the same local businesses that provided the vocational training, or from other businesses. This ensures an aid to the local economy, as the local region will retain the qualified workers, lowering unemployment rates and boosting the economy.

In some embodiments The portal will include a robust Learning Management System (LMS) and further a robust Content Management System (CMS), Certification management system, User management System (UMS), Advertisement management system, Job management system, video conferencing and social networking. The CMS allows for community, industry and education providers to add to the content pool by adding their own content that may be rated and reviewed by the community.

It will be apparent to one with skill in the art, that the embodiments described above are specific examples of a single broader invention which may have greater scope than any of the singular descriptions taught. There may be many alterations made in the descriptions without departing from the spirit and scope of the present invention.

What is claimed is:

1. A method comprising steps:
(a) logging in to an on-line vocational education portal by a person seeking to gain vocational training;
(b) guiding the person, by the vocational portal, through an aptitude test;
(c) directing the person to one or more on-line vocational courses based on the aptitude test results;
(d) guiding the user, by the vocational portal, through one or more assessment tests, determining the person's mastery of the one or more vocational courses; completion of the on-line course curriculum, the user is provided an assessment test; and
(e) providing and recording a certification to the person based upon successful completion of the one or more assessment tests.

2. The method of claim 1 further comprising steps for determining a geographic location for the person and presenting interfaces to the user in a language native to the geographic location.

3. The method of claim 1 wherein in step (c), the on-line vocational courses are provided by businesses that are located in close proximity to the geographical location of the user.

4. The method of claim 3 wherein in step (c), the entity is a local business and the on-line course curriculum is intended to train the user in a trade that is specific to the local business.

5. The method of claim 1 wherein in step (e), the certification meets an international standard.

6. The method of claim 1, further providing a step wherein the user is recruited for employment by a business that is located in close proximity to the geographical location of the user.

7. The method of claim 6, wherein the entity is a local business and the on-line course curriculum is provided to train the user in a trade that is specific to the local business.

8. A system comprising:
an Internet-connected computerized appliance having a processor and coupled to a data repository, the processor executing software from a non-transitory medium, the software providing an interactive interface to a vocational education system, the system enabling a user to:
log on and select a language;
create an account;
search through available courses;
take an aptitude test;
complete a course curriculum;
take an assessment test;
gain a certification;
search for employment; and
network with peers.

9. The system of claim 8, wherein the language is auto-suggested based on the geographical location of the user.

10. The system of claim 8, wherein course curriculum is provided by a business that is located in close proximity to the geographical location of the user.

11. The system of claim 10, wherein the course curriculum trains the user in a trade that is specific to the local business.
